(19) United States
(12) Patent Application Publication
(10) Pub. No.: US 2025/0103990 A1
(43) Pub. Date: Mar. 27, 2025

(54) WORKFLOW ORCHESTRATION USING A UNIVERSAL STATE MANAGER

(71) Applicant: DISNEY ENTERPRISES, INC., Burbank, CA (US)

(72) Inventors: Nicholas Jordan LEWIS, Saint Cloud, FL (US); Esther M. BETANCOURT, Clermont, FL (US); Kerry D. BRABBLE, Orlando, FL (US)

(21) Appl. No.: 18/476,171

(22) Filed: Sep. 27, 2023

(51) Int. Cl. G06Q 10/0633; G06Q 10/0631

(52) U.S. Cl. CPC G06Q 10/0633; G06Q 10/063112; G06Q 10/063114

(57) ABSTRACT

The present invention sets forth a technique for performing workflow orchestration in disparate computer systems and software applications using a universal state manager. This technique includes generating a unique job identifier for a requested automation workflow. The technique also includes retrieving a workflow template specifying phases and tasks associated with the requested automation workflow. The technique further includes associating one or more reference IDs generated by one or more system components to the unique job identifier, wherein each of the one or more system components performs at least a subset of tasks specified in the one or more phases. The technique further includes aggregating status reports generated by the one or more system components, correlating each status report with a corresponding reference ID associated with the system component that generated the status report, and generating a status of the requested automation workflow based on the status reports.

### BACKGROUND

### Field of the Various Embodiments

Embodiments of the present disclosure relate generally to Information Technology (IT) automation and, more specifically, to techniques for automatically orchestrating workflows in disparate computer systems and software applications.

### Description of the Related Art

Computer-implemented workflows including many different operations or actions are often broken up into a number of discrete tasks. These tasks require network or computer resources, which may be logically or physically co-located or may be separated. Further, each individual task may invoke one or more downstream software applications, with each software application potentially being provided by a different software vendor and operating disparately from other software applications. In some cases, task execution may require dependencies between software applications. For example, the output of one task may serve as the input for one or more additional tasks, or one task may need to achieve a particular status before a different task may begin or continue its operation. In short, managing computer-implemented workflows may require coordinating the execution of a number of downstream software applications from multiple vendors on a variety of disparate computing and network resources.

This wide variety of disparate downstream software applications hinders existing techniques for managing computer-implemented workflows. Each downstream software application may have its own context and data paradigms that are not aligned with one another and cannot be tracked in a managed and centralized manner. The software applications may lack a common communication protocol, further complicating techniques to manage, track, and acquire state information for tasks that have been assigned to the software applications.

Due to disparities among the various downstream software applications, there is no way to accurately assess and report the status of a workflow in real time. Without accurate, up-to-date status information, it is difficult to automate workflow execution, particularly if there are dependencies between tasks assigned to the disparate software applications.

As the foregoing illustrates, what is needed in the art are more effective techniques for automatically orchestrating workflows in disparate computer systems and software applications.

### SUMMARY

One embodiment of the present invention sets forth a technique for performing workflow orchestration using a universal state manager. The technique includes generating a unique job identifier associated with a requested automation workflow and retrieving a workflow template associated with the requested automation workflow. The workflow template includes one or more phases, with each phase specifying one or more tasks. The technique further includes associating one or more reference IDs generated by one or more system components to the unique job identifier. The one or more system components can be disparate software applications and each of the one or more system components performs at least a subset of tasks specified in the one or more phases. The technique further includes aggregating status reports generated by the one or more system components, correlating each status report with a corresponding reference ID associated with the system component that generated the status report, and generating a status of the requested automation workflow based on the status reports.

One technical advantage of the disclosed technique relative to the prior art is that the implementation is vendor-agnostic. The technique is applicable to any software framework or platform regardless of technology provider and does not require that downstream software applications share standardized data paradigms or communication protocols. The workflow orchestration platform centrally tracks and reports the status of jobs, phases, and tasks, and provides accurate, up-to-date status information. These centralized tracking and reporting features also facilitate workflow automation, particularly when there are dependencies between various tasks in a workflow. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an infrastructure configured to implement one or more aspects of the various embodiments.

FIG. 2 is a more detailed illustration of workflow orchestration platform 110 of FIG. 1, according to various embodiments.

FIG. 3 is a representation of the hierarchical structure of a requested workflow according to various embodiments.

FIG. 4 is a depiction of a workflow status display as provided to a user by GUI services 120 according to various embodiments.

FIG. 5 is a flow diagram of method steps for performing workflow orchestration, according to various embodiments.

FIG. 6 illustrates a computer system configured to implement one or more aspects of various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

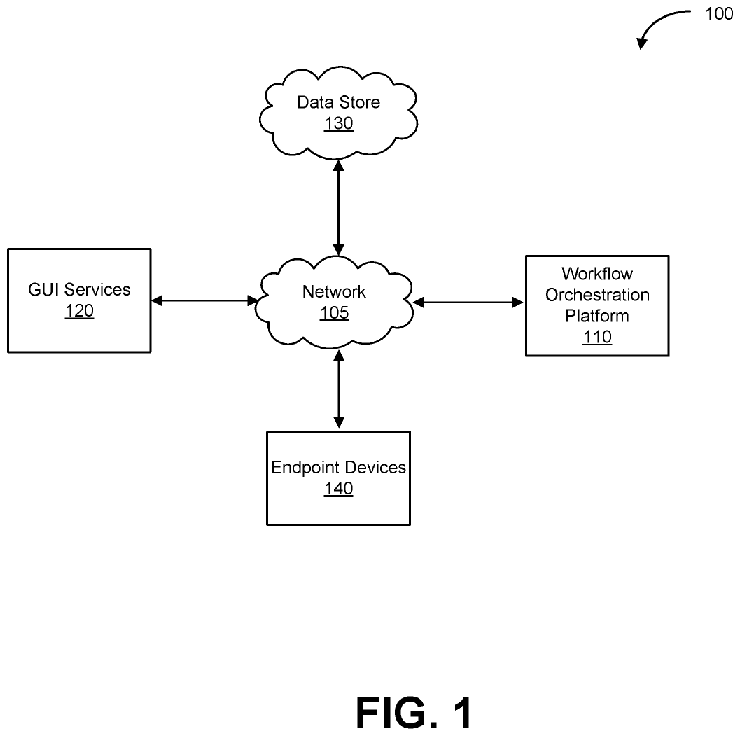

FIG. 1 illustrates an infrastructure configured to implement one or more aspects of the various embodiments. As shown, infrastructure 100 includes a workflow orchestration platform 110, one or more graphical user interface (GUI) services 120, a data store 130, and one or more endpoint devices 140, which are connected to one another and/or data store 130 via a communications network 105.

Each endpoint device 140 communicates with data store 130, workflow orchestration platform 110, and GUI services 120 via network 105 to transfer content, such as textual data, graphical data, configuration data, and other types of data. In various embodiments, endpoint devices 140 may include computer systems, software applications, or computer network devices implemented either virtually or in hardware.

Network 105 includes any technically feasible wired, optical, wireless, or hybrid network that transmits data between or among workflow orchestration platform 110, data store 130, endpoint devices 140, GUI services 120, and/or other components. For example, network 105 could include a wide area network (WAN), local area network (LAN), personal area network (PAN), WiFi network, cellular network, Ethernet network, Bluetooth network, universal serial bus (USB) network, satellite network, and/or the Internet.

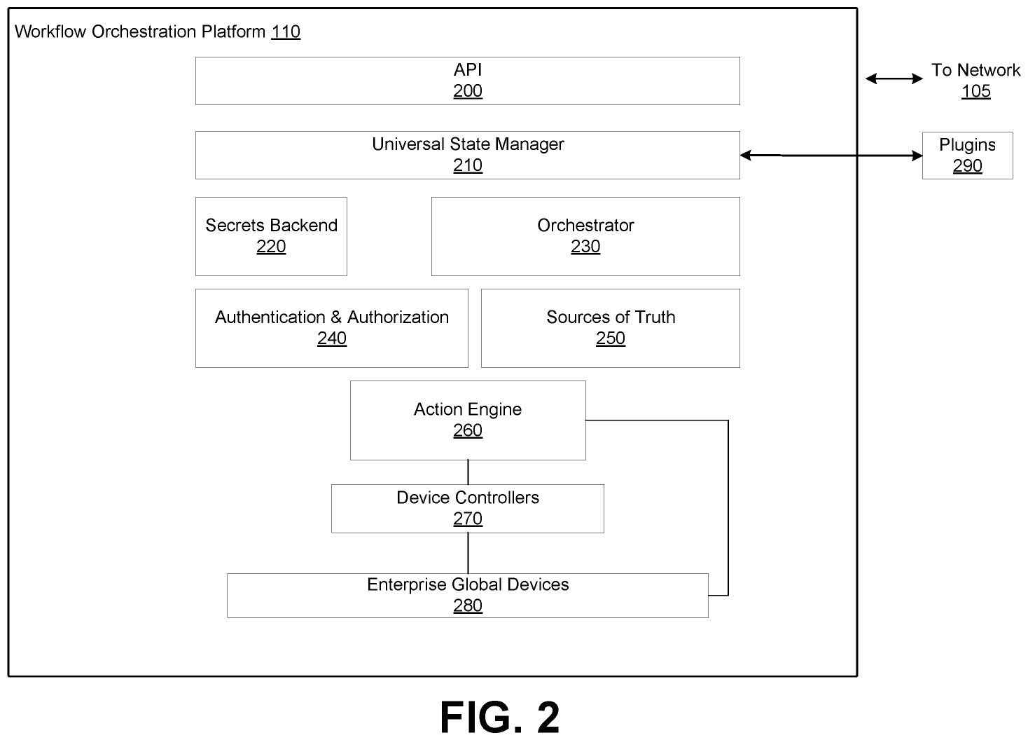

Workflow orchestration platform 110 coordinates, executes, and tracks the status of a variety of individual tasks necessary to successfully complete a user-requested workflow across a variety of disparate computer systems and components. Workflow orchestration platform 110 is shown in more detail in FIG. 2.

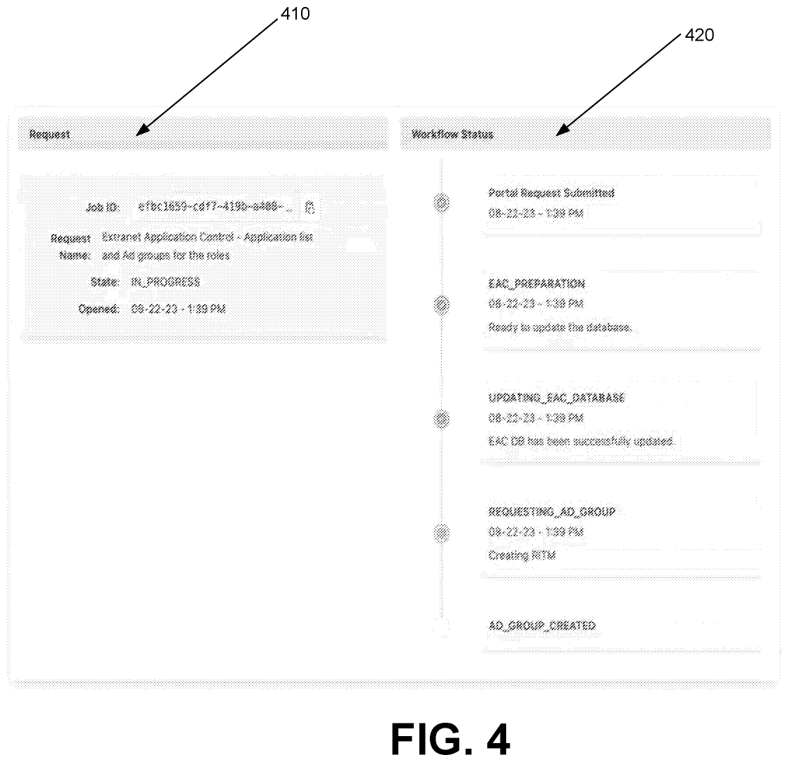

GUI services 120 provide an interface through which a user may initiate a workflow request, submit data associated with the workflow request, or view the status of a workflow request. GUI services 120 may display the overall status of a workflow request, as well as the status of individual phases or tasks included in the requested workflow. The workflow status displays of GUI services 120 are shown in more detail in FIG. 4. In various embodiments, GUI services 120 displays an Automation Marketplace that depicts a variety of available IT automation workflows and permits a user to select one or more automation workflows for execution.

In various embodiments, data store 130 may include file servers, hard disk drives, solid state storage devices, or similar storage devices. Data store 130 may also include an online storage service in which a catalog of files, including thousands or millions of files, is stored and accessed in order to exchange data with the various components in infrastructure 100. Although only a single instance of data store 130 is shown in FIG. 1, various embodiments of the present disclosure may implement multiple instances of data store 130.

FIG. 2 is a more detailed illustration of workflow orchestration platform 110 of FIG. 1, according to some embodiments. Workflow orchestration platform 110 coordinates and tracks disparate computer systems and software applications in the execution of individual tasks necessary to complete a user-requested workflow. As shown in FIG. 2, workflow orchestration platform 110 includes, without limitation, application program interface (API) 200, universal state manager 210, secrets backend 220, orchestrator 230, authentication & authorization 240, sources of truth 250, action engine 260, device controllers 270, enterprise global devices 280 and plugins 290.

As discussed above, workflow orchestration platform 110 coordinates and tracks the status of a workflow as the workflow is executed by a variety of disparate computer systems and components. In various embodiments, a workflow is a set of tasks that must be completed to achieve a particular goal. For example, a workflow may contain a set of tasks that must be completed to change configuration parameters in a remote network device. The tasks in a workflow may be grouped into one or more phases. Furthermore, a given task or phase in a workflow may have one or more dependencies on other tasks or phases in the workflow. For example, a dependency for a given phase may require that all tasks within a particular phase are complete before the tasks associated with that phase may be executed. A workflow may be user-requested or may be requested by other software platforms upstream from the workflow orchestration platform 110.

API 200 within workflow orchestration platform 110 receives a requested workflow to be executed, as well as data associated with the requested workflow. In various embodiments, the associated data may include information about the requesting entity (e.g., a user or an upstream software platform) or configuration parameters for the requested workflow. API 200 provides standardized communication protocols for computer systems and software applications to extract and exchange data. API 200 includes endpoints for various computer systems, software applications, and IT automation workflows, and each of these endpoints provides an interface for its associated system, application, or workflow. API 200 registers the requested workflow with universal state manager 210. Universal state manager 210 stores the API registration for the requested workflow in data store 130 and subsequently accesses the requested workflow through the API by specifying the API registration. API 200 initiates the execution of the requested workflow via orchestrator 230.

Universal state manager 210 centrally tracks the status of a workflow and collects and coordinates status reports from various system components that perform tasks and other actions associated with the requested workflow. Universal state manager 210 generates a job identifier (job ID) for the requested workflow. Each generated job ID is universally unique and serves as the primary identifier for the requested workflow. As system components perform various tasks in furtherance of the requested workflow, universal state manager 210 correlates these tasks with the requested workflow via the unique job ID.

Universal state manager 210 further associates metadata for the requested workflow with the assigned job ID. Metadata includes, for example, information about the requesting user or timestamps reflecting times when the requested workflow was created, started, or last updated. The metadata for the requested workflow may further include a workflow template associated with the requested workflow. Universal state manager 210 generates a workflow template ID for the workflow template and associates the workflow template ID with the assigned job ID for the requested workflow. The workflow template ID identifies a particular workflow template associated with the requested workflow.

Workflow templates are stored in data store 130 and each workflow template outlines one or more phases of execution necessary to successfully complete a particular automation workflow. Each phase includes a set of tasks representing the most basic units of work required to complete the workflow. In various embodiments, a workflow template may include dependencies requiring that a particular phase or task must be completed before another phase or task may begin. A dependency may further require external input to begin or complete a phase or task defined in the workflow template. For instance, a task may require authorization from a human user or may depend on data retrieved from an external computer system via plugins 290.

In various embodiments, pre-built workflow templates are created once for each workflow type and are referenced each time a user requests a workflow of the corresponding type. In other embodiments, universal state manager 210 may customize or otherwise modify a pre-built workflow template based on user input data associated with a user workflow request.

Orchestrator 230 is a software service that coordinates the individual tasks required to successfully complete a workflow in accordance with the workflow template associated with the workflow. As described above, API 200 initiates execution of the requested workflow via orchestrator 230. Universal state manager 210 retrieves the requested workflow template from data store 130 via network 105, and orchestrator 230 retrieves the workflow template for the requested workflow from universal state manager 210. Based on the workflow template ID, orchestrator 230 analyzes the workflow template and determines tasks to be assigned to enterprise global devices 280, subject to any dependencies described in the workflow template. Orchestrator 230 assigns individual tasks to enterprise global devices 280 via one or more of action engine 260 and device controllers 270. Orchestrator 230 generates an orchestrator ID as its own unique identifier and transmits the orchestrator ID to universal state manager 210.

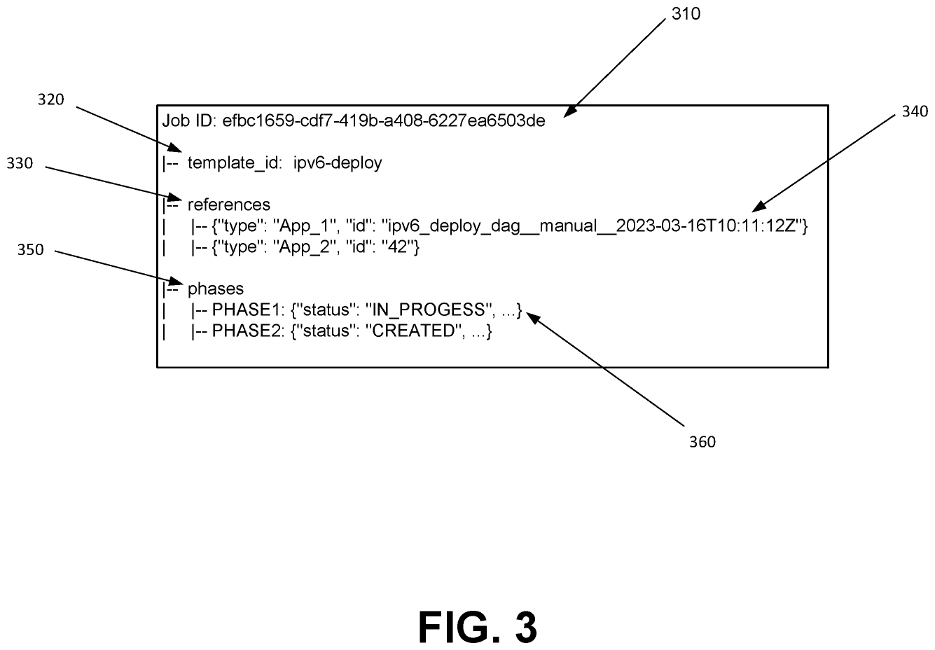

Universal state manager 210 stores the orchestrator ID in a reference table associated with the job ID for the requested workflow and associates the orchestrator ID with any status reports received from orchestrator 230 during the execution of the requested workflow. The reference table resides in data store 130 and includes at least one entry for each system component or enterprise global device 280 that performs work in furtherance of the requested workflow. The reference table entries permit universal state manager 210 to access any system component by reference using the component's reference ID. The reference table also permits a software component to receive or update information about the job by reference using only its own reference ID. Individual software components may, but are not required to, store or reference the job ID for the requested workflow. The reference table further allows a software component or user to request information associated with one or more software components that have performed tasks in furtherance of the requested workflow. Examples of reference table entries are discussed below in reference to FIG. 3.

Enterprise global devices 280 include integrated physical devices, virtual devices, and software applications that form an organization's global infrastructure. Orchestrator 230 performs tasks based on the workflow template for the requested workflow by directing modifications to enterprise global devices 280 via action engine 260 and/or device controllers 270.

Secrets backend 220 is a software module responsible for protecting system-level secrets and other sensitive data such as device credentials. Secrets backend 220 provides data and credentials to various individual components within workflow orchestration platform 110 as needed to complete tasks specified in the workflow template.

Authentication & authorization 240 manages a requesting entity's identity and role-based access control credentials across various components and services that perform tasks in a user-requested workflow. The requesting entity may be a user or an upstream software platform. Authentication and authorization 240 provides the credentials to action engine 260, enterprise global devices 280 and other system components including software applications, allowing action engine 260 to perform tasks in accordance with the requesting entity's access rights and permissions.

Sources of truth 250 include one or more databases holding trusted, accurate, and validated data used in workflow automation. Sources of truth 250 provide this data to enterprise global devices 280 as needed for the completion of the requested workflow.

Action engine 260 includes one or more components that deploy configuration changes to IT infrastructure components such as enterprise global devices 280 or cloud components. Action engine 260 may include computer systems, software applications, or computer infrastructure devices implemented either virtually or in hardware. Action engine 260 receives a task from orchestrator 230 and directs the task to one or more enterprise global devices 280 through device controllers 270. Device controllers 270 are modules native to each IT infrastructure component that allow the individual components to communicate with each other and with other computing systems over network 105. Device controllers 270 may be implemented in hardware or virtually in software. Action engine 260 may report completed configuration actions to universal state manager 210 and may further generate a status report for the configured enterprise global device 280 reflecting the configuration changes. Action engine 260 may further transmit the status report and the reference ID associated with action engine 260 to universal state manager 210.

Plugins 290 are software modules that provide data exchange capability between universal state manager 210 and one or more external computer systems. In various embodiments, a user or any component of workflow orchestration platform 110 may exchange data with external computer systems via universal state manager 210 and plugins 290. The user or component may also access and retrieve event logs or other historical log files located in an external computer system. The external computer systems may be virtual or physical and may be co-located with workflow orchestration platform 110 or located remotely.

In alternative embodiments, orchestrator 230 may assign one or more tasks in a requested workflow to action engines that reside in one or more external computer systems via universal state manager 210 and plugins 290. The external computer systems may in turn transmit status reports or other messages via plugins 290 to universal state manager 210. In alternative embodiments where the external computer systems are capable of formatting data for use by universal state manager 210, the external computer systems may transmit status reports or other messages directly to universal state manager, bypassing plugins 290. These reports or messages include corresponding self-generated reference IDs for components within the external computer system. Plugins 290 may also translate the received status reports or messages into any suitable format for universal state manager 210. In this manner, external computer systems tasked via plugins 290 may supplement or replace action engine 260 and/or device controllers 270 in the execution of tasks for a requested workflow.

FIG. 3 is a representation of the hierarchical structure of a requested workflow according to various embodiments. As shown, the hierarchical structure includes a workflow job ID 310, a workflow template ID 320, workflow references 330, reference ID 340, workflow phases 350 and phase status 360.

As described above in reference to FIG. 2, universal state manager 210 generates and assigns a job identifier (job ID) 310 to a requested workflow. Each generated job ID is universally unique and serves as the primary identifier for the requested workflow. Universal state manager 210 further associates a workflow template ID 320 with the job ID 310 for the requested workflow. Workflow template ID 320 identifies a particular workflow template associated with the requested workflow.

As orchestrator 230 coordinates the completion of various tasks and phases associated with a requested workflow and transmits status reports to universal state manager 210, universal state manager 210 further updates job ID 310 with the current state of the requested workflow.

The requested workflow includes a reference table of references 330 to aggregate the state of each individual component integrated into workflow orchestration platform 110, regardless of the component's technology vendor. References 330 include one or more instances of reference ID 340. Each reference ID 340 is self-generated by a system component such as action engine 260 or device controllers 270. As shown in FIG. 3, reference ID 340 is self-generated by software component “App_1” and has an assigned reference type of “App_1” and a value of “ipv6_deploy_dag_manual_2023-03-16T10:11:12Z”. FIG. 3 also shows a reference ID self-generated by software component “App_2” that has an assigned reference type “App_2” and a value of “42”. Although not depicted in FIG. 3, orchestrator 230 also reports its unique ID for inclusion in the reference table.

Universal state manager 210 aggregates the reference IDs and associates the reference IDs with job ID 310 for the requested workflow. Universal state manager 210 may obtain the status of a system component by reference using the reference type and the component's reference ID. An individual component may also automatically generate and transmit a report to orchestrator 230 when the status of a task changes and include the component's reference ID with the report.

The requested workflow includes one or more phases 350 described in the corresponding workflow template. As individual components complete tasks associated with a phase and transmit reports to orchestrator 230, orchestrator 230 updates universal state manager 210 with the status of the phase. As shown in FIG. 3, exemplary phase status 360 reflects that “PHASE1” is currently “IN_PROGRESS.”

FIG. 4 is a depiction of a workflow status display as provided to a user by GUI services 120 according to various embodiments. Request 410 of the status display shows information related to the requested workflow, including the job ID 310 assigned to the workflow and the name of the requested workflow. Request 410 further displays the overall state of the requested workflow (e.g., “IN_PROGRESS”), as well as the time and date the workflow was opened.

Workflow status 420 displays the status of the individual phases defined for the requested workflow. In various embodiments, workflow status 420 may indicate a completed phase with an icon depicting a filled circle and checkmark, while phases that are currently in progress may be indicated with a filled circle. Phases that have not yet begun may be indicated with an unfilled circle. Workflow status 420 may also assign a color code to an icon or other phase indicator based on the status of the phase. The displayed status for each phase may include a time and date when the phase commenced, as well as a textual description of the status of the phase. At any time, a user may query the workflow orchestration platform via GUI services 120 and receive status or progress information for a task, phase, or workflow.

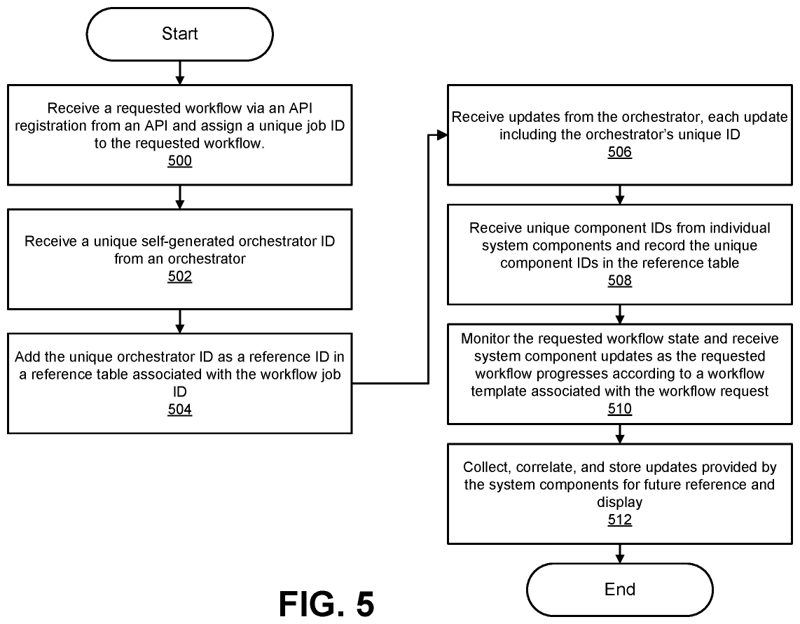

FIG. 5 is a flow diagram of method steps for performing workflow orchestration, according to various embodiments. Although the method steps are described in conjunction with the systems of FIGS. 1-2 and 6, persons skilled in the art will understand that any system configured to perform the method steps in any order falls within the scope of the present disclosure.

As shown, in operation 500, universal state manager 210 receives the requested workflow via an API registration from API 200 and assigns a unique job ID 310 to the requested workflow.

In operation 502, universal state manager 210 receives a unique self-generated orchestrator ID from orchestrator 230.

In operation 504, universal state manager 210 adds the orchestrator's unique ID as a reference ID in a reference table 330 associated with the job ID 310 for the requested workflow.

In operation 506, universal state manager 210 receives and records updates from orchestrator 230. Each update includes the orchestrator's reference ID.

In operation 508, universal state manager 210 receives a unique ID from each system component that performs one or more tasks in the requested workflow. The workflow orchestration platform records each unique ID as a reference ID in reference table 330. In various embodiments, each system component may generate one or more unique IDs during the execution of the requested workflow and universal state manager 210 may record each of these unique IDs as a separate reference ID in reference table 330.

In operation 510, universal state manager 210 monitors the state of the requested workflow and receives updates from individual system components as the workflow progresses according to the workflow template associated with the requested workflow. Universal state manager 210 may also receive updates directly from orchestrator 230. Updates from orchestrator 230, action engine 260, or other system components include the associated unique reference ID for the system component. Universal state manager 210 associates the received updates with orchestrator 230, action engine 260, or other system component based on the reference table associated with the requested workflow's job ID. In various embodiments, universal state manager 210 may receive a status report that includes a job ID for a workflow rather than a unique reference ID for a system component. In this manner, system components that do not have an associated unique reference ID may transmit status reports for a particular workflow to universal state manager 210.

In operation 512, universal state manager 210 continues to collect, correlate, and store orchestrator and system component updates for future reference and display until the requested workflow terminates. The requested workflow may terminate upon successful completion, or the workflow may terminate unsuccessfully and return one or more error indications to universal state manager 210. The requested workflow may also terminate based on a user-requested cancellation or an automated cancellation request generated by conditional logic defined in the workflow template for the requested workflow.

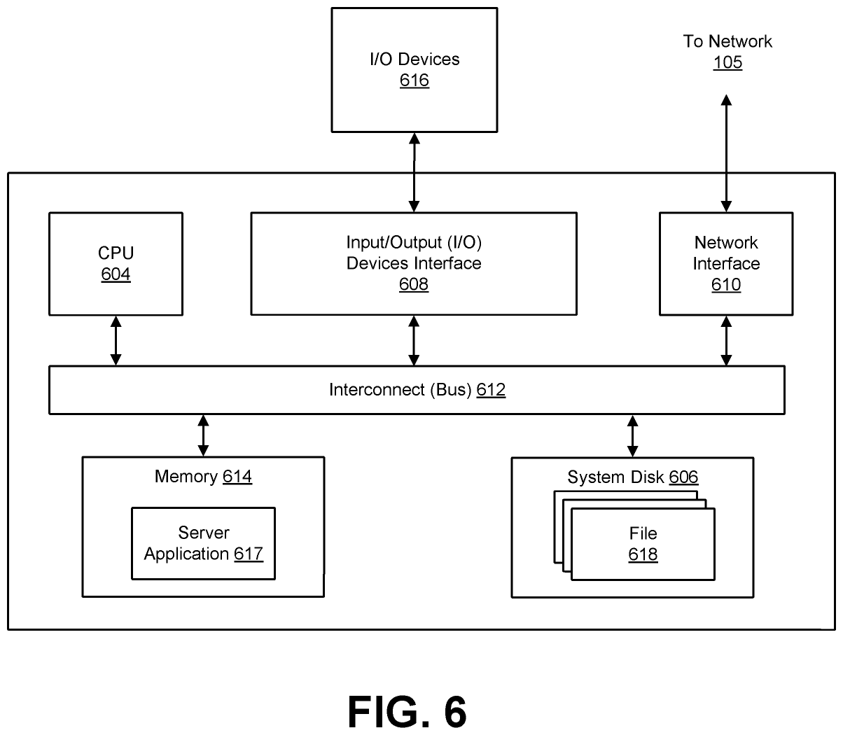

FIG. 6 illustrates a computer system configured to implement one or more aspects of various embodiments. As shown, the computer system includes, without limitation, a central processing unit (CPU) 604, a system disk 606, an input/output (I/O) devices interface 608, a network interface 610, an interconnect 612, and a system memory 614.

CPU 604 is configured to retrieve and execute programming instructions, such as a server application 617, stored in system memory 614. Similarly, CPU 604 is configured to store application data (e.g., software libraries) and retrieve application data from system memory 614. Interconnect 612 is configured to facilitate transmission of data, such as programming instructions and application data, between CPU 604, system disk 606, I/O devices interface 608, network interface 610, and system memory 614. I/O devices interface 608 is configured to receive input data from I/O devices 616 and transmit the input data to CPU 604 via interconnect 612. For example, I/O devices 616 may include one or more buttons, a keyboard, a mouse, and/or other input devices. I/O devices interface 608 is further configured to receive output data from CPU 604 via interconnect 612 and transmit the output data to I/O devices 616.

System disk 606 may include one or more hard disk drives, solid state storage devices, or similar storage devices. System disk 606 is configured to store non-volatile data such as files 618 (e.g., application files, software libraries, etc.). Files 618 can then be retrieved by one or more endpoint devices 140 or enterprise global devices 280 via network 105. In some embodiments, network interface 610 is configured to operate in compliance with the Ethernet standard.

System memory 614 includes server application 617, which is configured to service requests received from an endpoint device 140 or enterprise global device 280 for one or more files 618. When server application 617 receives a request for a given file 618, server application 617 retrieves the requested file 618 from system disk 606 and transmits file 618 to an endpoint device 140 or enterprise global device 280 via network 105. In alternative embodiments, some or all of files 618 may instead be stored in a data store 130, or in any other technically feasible location within infrastructure 100.

In sum, a universal state manager receives, coordinates, tracks, and reports the status of a user-requested automated information technology (IT) workflow that is executed across disparate hardware resources and software applications. In operation, the universal state manager assigns a universally unique job identifier (job ID) to the requested workflow. The universal state manager uses the job ID as the primary identifier to correlate units of work for the requested workflow across various hardware and software systems. Each requested workflow includes associated metadata, such as a workflow template and timestamps for job creation, job commencement, and last status update. The workflow template defines a sequence of one or more phases required to successfully complete the request job. Each phase defines a set of one or more tasks required to complete the phase within the workflow, as well as the individual components within the computing system required to complete the tasks. The tasks may be executed in parallel or may be executed in a particular sequence.

Individual components within a computing system may include hardware resources and software applications from a variety of different vendors. Each individual component self-generates one or more component IDs associated with an assigned task. The universal state manager aggregates the component IDs associated with a particular workflow, records each component ID as a reference ID, and maps the reference IDs to the job ID in a reference table. In this manner, the universal state manager maintains a list of reference IDs for all components associated with a workflow and may obtain the status of a component by reference. An individual component may also automatically generate a report when the status of a task changes. This report includes a component ID associated with the task, which the universal state manager associates with the corresponding reference ID to record the change in status. Alternatively, the report may include the job ID for the requested workflow. The universal state manager compares the status of individual components to the requirements of the workflow template to track the progress of individual tasks and phases, as well as the overall progress of the requested job. At any time, a user may query the workflow orchestration platform and receive status or progress information for a task, phase, or workflow.

One technical advantage of the disclosed technique relative to the prior art is that the implementation is vendor-agnostic. The technique is applicable to any software framework or platform regardless of technology provider and does not require that downstream software applications share standardized data paradigms or communication protocols. The workflow orchestration platform centrally tracks and reports the status of workflows, phases, and tasks, and provides accurate, up-to-date status information. These centralized tracking and reporting features also facilitate workflow automation, particularly when there are dependencies between various tasks in a workflow. These technical advantages provide one or more technological improvements over prior art approaches.

1. In various embodiments, a computer-implemented method comprises generating a unique job identifier associated with a requested automation workflow, retrieving a workflow template associated with the requested automation workflow, the workflow template comprising one or more phases, each phase specifying one or more tasks, associating one or more reference IDs generated by one or more system components to the unique job identifier, wherein each of the one or more system components performs at least a subset of tasks specified in the one or more phases, aggregating status reports generated by the one or more system components, correlating each status report with a corresponding reference ID associated with the system component that generated the status report, and generating a status of the requested automation workflow based on the status reports.

2. The computer-implemented method of clause 1, wherein the workflow template further comprises one or more dependencies.

3. The computer-implemented method of clauses 1 or 2, wherein at least one dependency specifies one or more tasks or phases that must be completed before a different specified task or phase may commence.

4. The computer-implemented method of any of clauses 1-3, wherein at least one dependency specifies one or more tasks that have an approval requirement.

5. The computer-implemented method of any of clauses 1-4, further comprising generating, based on the reference ID associated with a particular system component, a status request for the particular system component, transmitting the status request to the particular system component, and receiving, from the particular system component, a status report.

6. The computer-implemented method of any of clauses 1-5, wherein the status of the requested automation workflow comprises one or more of a progress status of the requested automation workflow and a progress status of a phase or task specified by the workflow template.

7. The computer-implemented method of any of clauses 1-6, further comprising receiving a request for the status of the requested automation workflow and displaying the status of the requested automation workflow via a graphical user interface.

8. The computer-implemented method of any of clauses 1-7, further comprising receiving identity and role-based access control credentials associated with a requesting entity, associating the identity and role-based access control credentials with the unique job identifier associated with the requested automation workflow, and transmitting the identity and role-based access control credentials to the one or more system components.

9. The computer-implemented method of any of clauses 1-8, wherein the requesting entity is an upstream software platform.

10. In various embodiments, one or more non-transitory computer-readable media store instructions that, when executed by one or more processors, cause the one or more processors to perform the steps of generating a unique job identifier associated with a requested automation workflow, retrieving a workflow template associated with the requested automation workflow, the workflow template comprising one or more phases, each phase specifying one or more tasks, associating one or more reference IDs generated by one or more system components to the unique job identifier, wherein each of the one or more system components performs at least a subset of tasks specified in the one or more phases, aggregating status reports generated by the one or more system components, correlating each status report with a corresponding reference ID associated with the system component that generated the status report, and generating a status of the requested automation workflow based on the status reports.

11. The one or more non-transitory computer-readable media of clause 10, wherein the workflow template further comprises one or more dependencies.

12. The one or more non-transitory computer-readable media of clauses 10 or 11, wherein at least one dependency specifies one or more tasks or phases that must be completed before a different specified task or phase may commence.

13. The one or more non-transitory computer-readable media of any of clauses 10-12, wherein at least one dependency specifies one or more tasks that have an approval requirement.

14. The one or more non-transitory computer-readable media of any of clauses 10-13, further comprising generating, based on the reference ID associated with a particular system component, a status request for the particular system component, transmitting the status request to the particular system component, and receiving, from the particular system component, a status report.

15. The one or more non-transitory computer-readable media of any of clauses 10-14, wherein the status of the requested automation workflow comprises one or more of a progress status of the requested automation workflow and a progress status of a phase or task specified by the workflow template.

16. The one or more non-transitory computer-readable media of any of clauses 10-15, further comprising receiving a request for the status of the requested automation workflow and displaying the status of the requested automation workflow via a graphical user interface.

17. The one or more non-transitory computer-readable media of any of clauses 10-16, further comprising receiving identity and role-based access control credentials associated with a requesting entity, associating the identity and role-based access control credentials with the unique job identifier associated with the requested automation workflow, and transmitting the identity and role-based access control credentials to the one or more system components.

18. The one or more non-transitory computer-readable media of any of clauses 10-17, wherein the requesting entity is an upstream software platform.

19. In various embodiments, a computer-implemented method comprises generating a unique job identifier associated with a requested automation workflow, retrieving a workflow template associated with the requested automation workflow, the workflow template comprising one or more phases, each phase specifying one or more tasks, assigning, via a plugin associated with an external computing system, one or more tasks to one or more external system components located in the external computing system, associating one or more reference IDs generated by one or more external system components to the unique job identifier, wherein each of the one or more external system components performs at least a subset of tasks specified in the one or more phases, receiving, via the plugin, status reports generated by the one or more external system components, correlating each status report with a corresponding reference ID associated with the external system component that generated the status report; and generating a status of the requested automation workflow based on the status reports.

20. The computer-implemented method of clause 19, further comprising generating, based on the reference ID associated with a particular external system component, a status request for the particular external system component, transmitting, via the plugin, the status request to the particular external system component, and receiving, via the plugin, a status report from the particular external system component.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing workflow orchestration, the computer-implemented method comprising:
generating a unique job identifier associated with a requested automation workflow;
retrieving a workflow template associated with the requested automation workflow, the workflow template comprising one or more phases, each phase specifying one or more tasks;
associating one or more reference IDs generated by one or more system components to the unique job identifier, wherein each of the one or more system components performs at least a subset of tasks specified in the one or more phases;
aggregating status reports generated by the one or more system components;
correlating each status report with a corresponding reference ID associated with the system component that generated the status report; and
generating a status of the requested automation workflow based on the status reports.

2. The computer-implemented method of claim 1, wherein the workflow template further comprises one or more dependencies.

3. The computer-implemented method of claim 2, wherein at least one dependency specifies one or more tasks or phases that must be completed before a different specified task or phase may commence.

4. The computer-implemented method of claim 2, wherein at least one dependency specifies one or more tasks that have an approval requirement.

5. The computer-implemented method of claim 1, further comprising:
generating, based on the reference ID associated with a particular system component, a status request for the particular system component;
transmitting the status request to the particular system component; and
receiving, from the particular system component, a status report.

6. The computer-implemented method of claim 1, wherein the status of the requested automation workflow comprises one or more of a progress status of the requested automation workflow and a progress status of a phase or task specified by the workflow template.

7. The computer-implemented method of claim 6, further comprising:
receiving a request for the status of the requested automation workflow; and
displaying the status of the requested automation workflow via a graphical user interface.

8. The computer-implemented method of claim 1, further comprising:
receiving identity and role-based access control credentials associated with a requesting entity;
associating the identity and role-based access control credentials with the unique job identifier associated with the requested automation workflow; and
transmitting the identity and role-based access control credentials to the one or more system components.

9. The computer-implemented method of claim 8, wherein the requesting entity is an upstream software platform.

10. One or more non-transitory computer-readable media storing instructions that, when executed by one or more processors, cause the one or more processors to perform the steps of:
generating a unique job identifier associated with a requested automation workflow;
retrieving a workflow template associated with the requested automation workflow, the workflow template comprising one or more phases, each phase specifying one or more tasks;
associating one or more reference IDs generated by one or more system components to the unique job identifier, wherein each of the one or more system components performs at least a subset of tasks specified in the one or more phases;
aggregating status reports generated by the one or more system components;
correlating each status report with a corresponding reference ID associated with the system component that generated the status report; and
generating a status of the requested automation workflow based on the status reports.

11. The one or more non-transitory computer-readable media of claim 10, wherein the workflow template further comprises one or more dependencies.

12. The one or more non-transitory computer-readable media of claim 11, wherein at least one dependency specifies one or more tasks or phases that must be completed before a different specified task or phase may commence.

13. The one or more non-transitory computer-readable media of claim 11, wherein at least one dependency specifies one or more tasks that have an approval requirement.

14. The one or more non-transitory computer-readable media of claim 10, further comprising:
generating, based on the reference ID associated with a particular system component, a status request for the particular system component;
transmitting the status request to the particular system component; and
receiving, from the particular system component, a status report.

15. The one or more non-transitory computer-readable media of claim 10, wherein the status of the requested automation workflow comprises one or more of a progress status of the requested automation workflow and a progress status of a phase or task specified by the workflow template.

16. The one or more non-transitory computer-readable media of claim 15, further comprising:
receiving a request for the status of the requested automation workflow; and
displaying the status of the requested automation workflow via a graphical user interface.

17. The one or more non-transitory computer-readable media of claim 10, further comprising:
receiving identity and role-based access control credentials associated with a requesting entity;
associating the identity and role-based access control credentials with the unique job identifier associated with the requested automation workflow; and
transmitting the identity and role-based access control credentials to the one or more system components.

18. The one or more non-transitory computer-readable media of claim 17, wherein the requesting entity is an upstream software platform.

19. A computer-implemented method for performing workflow orchestration, the computer-implemented method comprising:
generating a unique job identifier associated with a requested automation workflow;
retrieving a workflow template associated with the requested automation workflow, the workflow template comprising one or more phases, each phase specifying one or more tasks;
assigning, via a plugin associated with an external computing system, one or more tasks to one or more external system components located in the external computing system;
associating one or more reference IDs generated by one or more external system components to the unique job identifier, wherein each of the one or more external system components performs at least a subset of tasks specified in the one or more phases;
receiving, via the plugin, status reports generated by the one or more external system components;
correlating each status report with a corresponding reference ID associated with the external system component that generated the status report; and
generating a status of the requested automation workflow based on the status reports.

20. The computer-implemented method of claim 19, further comprising:
generating, based on the reference ID associated with a particular external system component, a status request for the particular external system component;
transmitting, via the plugin, the status request to the particular external system component; and
receiving, via the plugin, a status report from the particular external system component.
